(19) United States
(12) Patent Application Publication
(10) Pub. No.: US 2016/0037123 A1
(43) Pub. Date: Feb. 4, 2016

(54) SYSTEM AND METHOD FOR INPUT SENSING FOR INTERNET PROTOCOL ENCODERS

(71) Applicant: AT&T Intellectual Property I, LP, Atlanta, GA (US)

(72) Inventors: Todd W. Jones, Kansas City, MO (US); Douglas Medina, Grain Valley, MO (US); Frank Mitchals, Gladstone, MO (US)

(21) Appl. No.: 14/447,786

(22) Filed: Jul. 31, 2014

(51) Int. Cl. H04N 7/01; H04N 19/70; H04N 5/04

(52) U.S. Cl. CPC H04N 7/0125; H04N 5/04; H04N 19/70

(57) ABSTRACT

Aspects of the subject disclosure may include, for example, a digital interface of an internet protocol encoder including a connector for connecting to a cable delivering a signal, and a sensor at the digital interface for sensing a characteristic of the signal. The sensed characteristic is a clock rate corresponding to an asynchronous serial interface signal or a data rate corresponding to a high-definition serial digital interface signal. An automatic switch routes the signal to a first decoder portion or a second decoder portion in accordance with the sensed characteristic. Other embodiments are disclosed.

### FIELD OF THE DISCLOSURE

The subject disclosure relates to a system and method for automatically sensing an input signal to an internet protocol encoder.

### BACKGROUND

Video transport signals (typically with embedded audio content) can be of several distinct types, including High-Definition Serial Digital Interface (HD-SDI) and Asynchronous Serial Interface (ASI) signals. Signal transmissions typically have content that is directed to specific inputs on an IP encoder depending on the type of signal.

### BRIEF DESCRIPTION OF THE DRAWINGS

Reference will now be made to the accompanying drawings, which are not necessarily drawn to scale, and wherein:

FIG. 1 depicts an illustrative embodiment of a system for sensing and automatically switching a signal directed to an internet protocol (IP) encoder;

FIG. 2 schematically illustrates the system of FIG. 1, including an input portion, a sensor and a processor;

FIG. 3 is a flowchart illustrating a method used in portions of the system described in FIGS. 1 and 2;

FIGS. 4-5 depict illustrative embodiments of communication systems that provide media services via video and audio/video signals that are automatically switched and directed to an IP encoder as shown in FIGS. 1-3;

FIG. 6 depicts an illustrative embodiment of a web portal for interacting with the communication systems of FIGS. 4-5;

FIG. 7 depicts an illustrative embodiment of a communication device; and

FIG. 8 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for automatically sensing an input signal to an internet protocol (IP) encoder, distinguishing between types of input signals (particularly video transport signals), and automatically switching within the encoder based on the type of input signal. Other embodiments are described in the subject disclosure.

One or more aspects of the subject disclosure include an automatic sensor for detecting a time base (or a data rate) of a audio/video signal input to an IP encoder, and an automatic switch for routing the signal to an input decoder portion of the IP encoder according to the presence or absence of that time base (or data rate).

One embodiment of the subject disclosure includes an apparatus comprising an input portion for connecting to a cable delivering a signal and a sensor coupled to the input portion for sensing a time base of the signal; the signal comprises a transport signal with embedded content and the sensor comprises a phase lock loop. The apparatus also comprises a switch for routing the signal, a memory to store executable instructions, and a processor coupled to the memory. The processor, responsive to executing the instructions, performs operations. The operations comprise determining, in accordance with the sensed time base of the signal, whether the signal is of a first type or a second type, and automatically directing the switch to route the signal to a first input decoder or a second input decoder in accordance with the determining The first type of signal is an asynchronous serial interface signal and the second type of signal is a high-definition serial digital interface signal.

One embodiment of the subject disclosure includes an apparatus comprising an input portion for connecting to a cable delivering a signal having embedded video content, a sensor coupled to the input portion for sensing a data rate of the signal, and a switch for routing the signal. The apparatus also comprises a memory to store executable instructions and a processor coupled to the memory. The processor, responsive to executing the instructions, performs operations. The operations comprise determining, in accordance with the sensed data rate of the signal, whether the signal is of a first type or a second type, and automatically directing the switch to route the signal to one of a plurality of input decoders in accordance with the determining The first type of signal is an asynchronous serial interface signal and the second type of signal is a high-definition serial digital interface signal.

One embodiment of the subject disclosure includes a method comprising receiving a signal at an input portion of an internet protocol encoder and sensing a characteristic of the signal. The method further comprises automatically routing the signal to a first decoder portion or a second decoder portion of the internet protocol encoder in accordance with the sensed characteristic. The characteristic of the signal is a clock rate corresponding to a first type of signal or a data rate corresponding to a second type of signal.

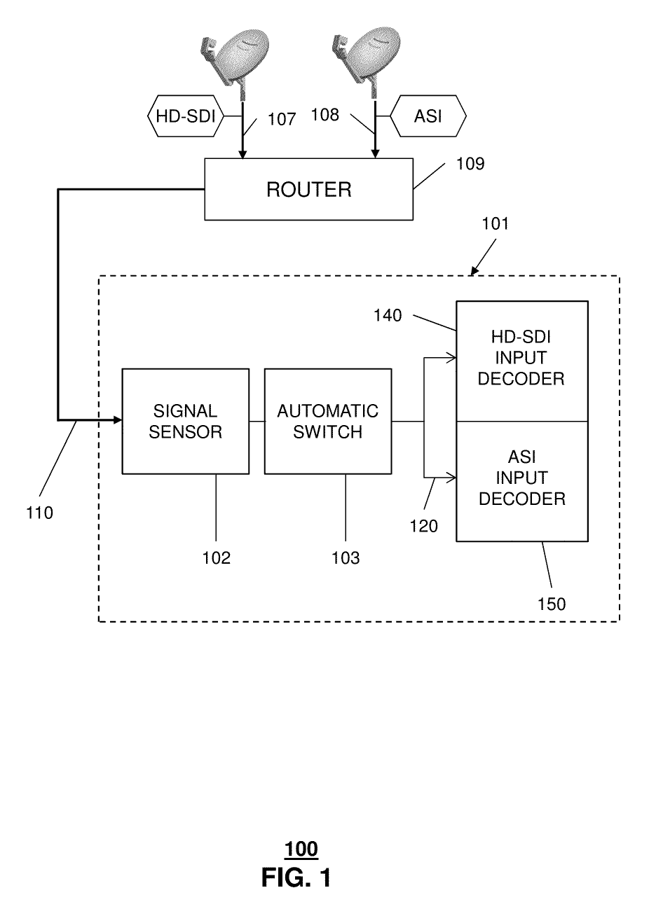

FIG. 1 schematically depicts a system 100 in which video delivery transmissions are routed to an IP encoder, either as HD-SDI or ASI signals. As shown in FIG. 1, HD-SDI and ASI signals can be transmitted on autonomous cable paths 107, 108 from satellite receivers and input to a router 109. According to an embodiment of the disclosure, both types of signals can be routed to the same encoder 101 over the same path (e.g. cable 110, typically a coaxial cable) and to a single input at encoder 101.

In this embodiment, the HD-SDI and ASI signals are both video transport signals with embedded audio/video content. Both types of signals use the same type of cable and input connector to encoder 101. The incoming signal is automatically detected at a signal sensor 102. Sensor 102 also detects the time base of the incoming signal. In this embodiment, sensor 102 includes a phase lock loop to sense the presence of a 270 MHz clock signal. Sensing a 270 MHz clock signal indicates that the incoming signal is an ASI type signal. The signal is then input to an automatic switch 103 that routes the signal 120 to an ASI input decoder portion 150 of the encoder 101. If a 270 MHz clock signal is not sensed, the signal is routed by automatic switch 103 to an HD-SDI input decoder portion 140 of encoder 101.

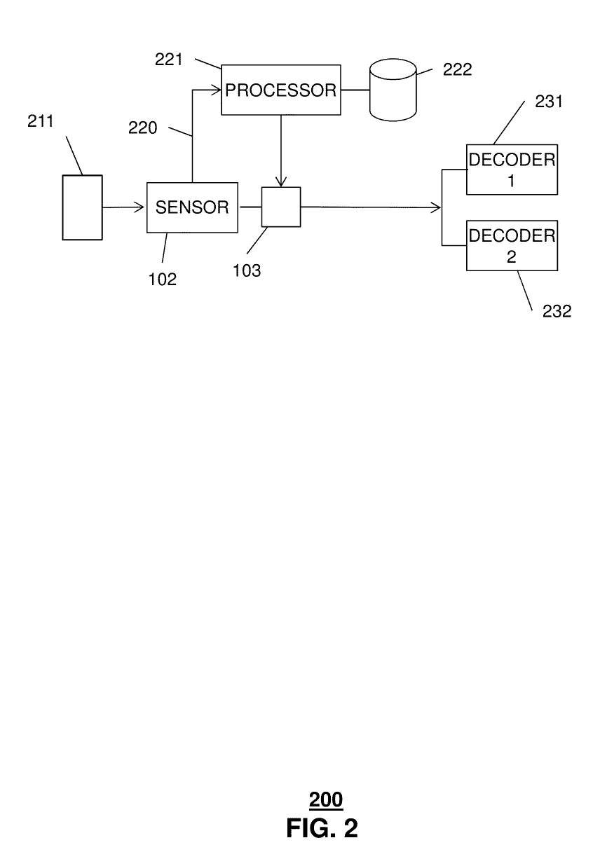

FIG. 2 schematically illustrates an apparatus 200 including a sensor and automatic switch according to an embodiment of the disclosure. Input portion 211 is coupled to sensor 102; in this embodiment, input portion 211 includes a BNC bulkhead connector for connecting to a coaxial cable. A single BNC bulkhead connector is sufficient to input both HD-SDI and ASI signals to the encoder. An internal signal 220 sent from sensor 102 to processor 221 indicates the presence or absence of a 270 MHz clock rate in the incoming audio/video signal. Processor 221 then routes automatic switch 103 to route the incoming signal to one of the input decoder portions 231, 232 of the encoder.

In an embodiment, apparatus 200 comprises a digital interface of the encoder. In a particular embodiment, the input decoder portions 231, 232 are internal to the encoder.

The processor 221 can execute a variety of procedures for determining the type of audio/video signal, in accordance with instructions stored in memory 222 coupled to the processor. For example, in an alternate embodiment, sensor 102 can be configured to detect the data rate of the incoming signal. Sensing a 1.48 Gbit/sec data rate indicates that the incoming signal is an HD-SDI signal. Processor 221 can then routes automatic switch 103 to route the incoming signal to one of the input decoder portions, based on the presence or absence of the HD-SDI data rate.

In these embodiments, the sensor 102 does not need to evaluate the time base of the audio/video signal, other than to determine whether or not a 270 MHz clock rate is present. Similarly, if the sensor is configured to detect the presence of an HD-SDI signal, the sensor need only determine whether the data rate is 1.48 Gbit/sec.

In an embodiment where the sensor is configured to detect presence of a 270 MHz clock rate, the automatic switch can be preset to route the audio/video signal to the ASI input decoder. The switch need only reroute the audio/video signal in a failover situation (that is, when the 270 MHz clock rate is not detected). Similarly, if the sensor is configured to detect presence of a 1.48 Gbit/sec data rate, the automatic switch can be preset to route the audio/video signal to the HD-SDI input encoder and reroutes the signal only in a failover situation where the 1.48 Gbit/sec data rate is not detected.

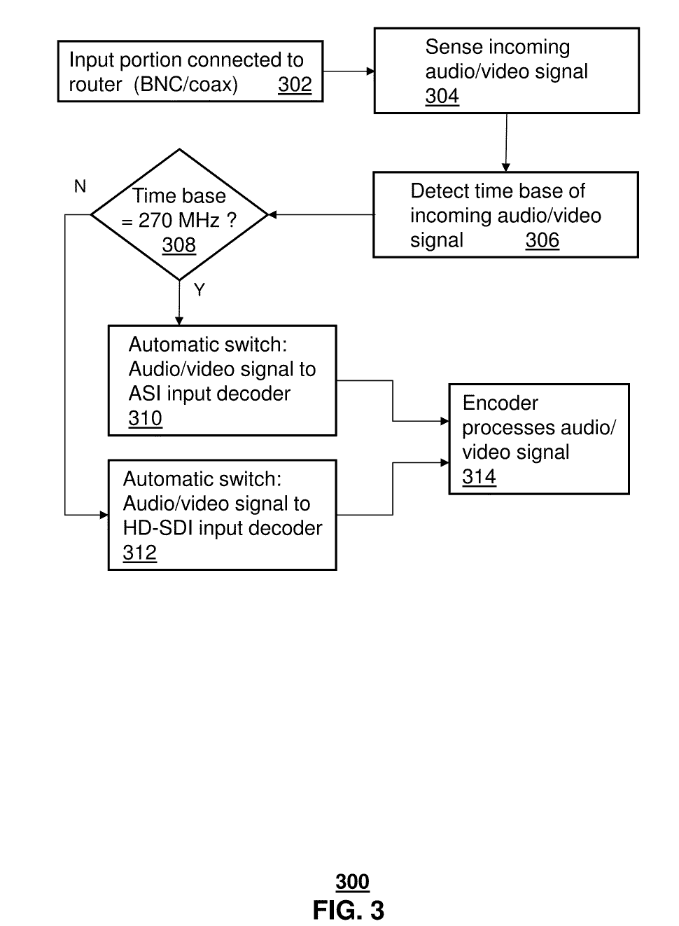

FIG. 3 is a flowchart illustrating a procedure 300 for switching an incoming signal based on the signal time base, according to an embodiment of the disclosure. An audio/video signal is received from a router connected to the input portion (step 302), and is sensed by the automatic sensor (e.g. a phase lock loop) in step 304. The sensor detects the time base of the incoming signal (step 306). The sensor indicates whether the time base corresponds to the 270 MHz clock rate that characterizes ASI signals (step 308). If so, the automatic switch routes the audio/video signal to the ASI input decoder portion of the encoder (step 310). The absence of a 270 MHz clock rate is interpreted as an HD-SDI signal, and the automatic switch routes the audio/video signal to the HD-SDI input decoder portion of the encoder (step 312). The encoder can then process the incoming signal (step 314) with the type of signal automatically determined.

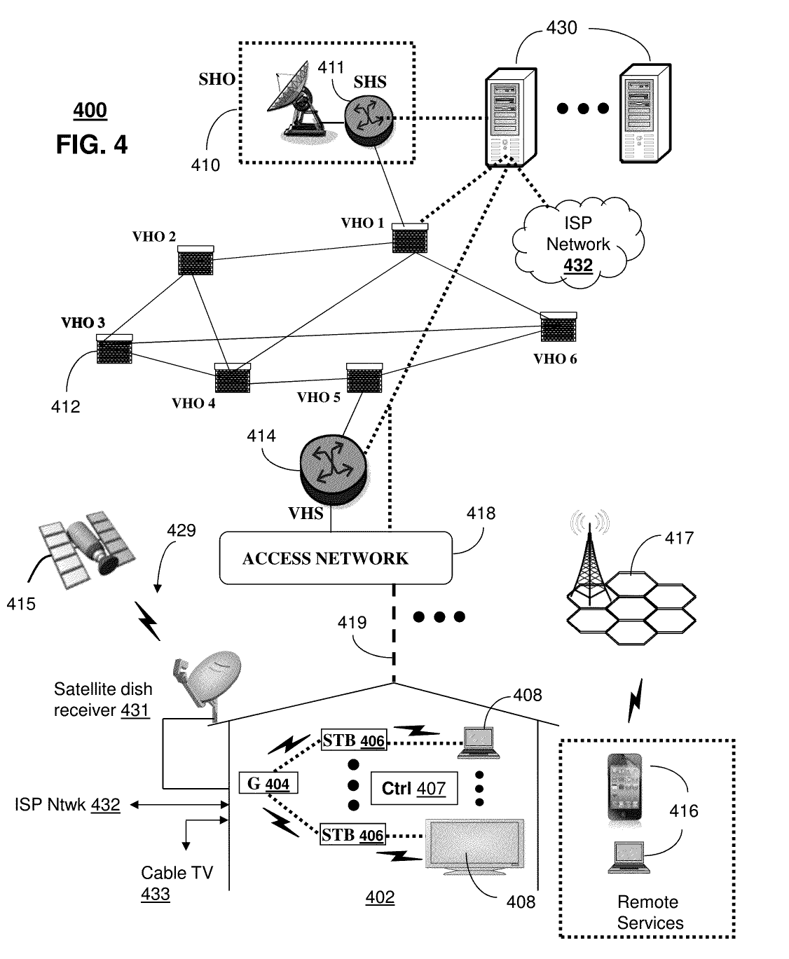

FIG. 4 depicts an illustrative embodiment of a first communication system 400 for delivering media content. The communication system 400 can represent an Internet Protocol Television (IPTV) media system. Communication system 400 can be overlaid or operably coupled with the systems 100, 200 of FIG. 1 and/or FIG. 2 as another representative embodiment of communication system 400. For example, satellite dish receiver 431 can be coupled to router 109, which delivers an ASI or HD-SDI transport signal to encoder 101. The type of signal can be automatically determined and processed by the encoder by using an apparatus comprising an input portion for connecting to a cable delivering the signal, a sensor (comprising a phase lock loop) coupled to the input portion for sensing a time base of the signal, and a switch for routing the signal. This apparatus can also comprise a memory to store executable instructions and a processor coupled to the memory that performs operations responsive to executing the instructions; the operations can comprise determining, in accordance with the sensed time base of the signal, whether the signal is of a first type or a second type, and automatically directing the switch to route the signal to a first input decoder or a second input decoder in accordance with the determining In this embodiment, the first type of signal is an asynchronous serial interface signal and the second type of signal is a high-definition serial digital interface signal.

The IPTV media system can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 418 to commercial and/or residential buildings 402 housing a gateway 404 (such as a residential or commercial gateway). The access network 418 can represent a group of digital subscriber line access multiplexers (DSLAMs) located in a central office or a service area interface that provide broadband services over fiber optical links or copper twisted pairs 419 to buildings 402. The gateway 404 can use communication technology to distribute broadcast signals to media processors 406 such as Set-Top Boxes (STBs) which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416.

Communication system 400 can also provide for all or a portion of the computing devices 430 to function as a remote processor to perform some or all of the functions described above with regard to FIGS. 1-3.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure. FIG. 5 depicts an illustrative embodiment of a communication system 500 employing an IP Multimedia Subsystem (IMS) network architecture to facilitate the combined services of circuit-switched and packet-switched systems. Communication system 500 can be overlaid or operably coupled with the systems 100, 200 of FIG. 1 and/or FIG. 2 and communication system 400 as another representative embodiment of communication system 400. In particular, system 500 can be operably coupled to an internet protocol encoder including a digital interface portion, a first input decoder portion and a second input decoder portion, in which an improvement comprises a connector for connecting to a cable delivering a signal, a sensor at the digital interface portion for sensing a characteristic of the signal, and an automatic switch for routing the signal to the first decoder portion or the second decoder portion in accordance with the sensed characteristic. The characteristic of the signal is a clock rate corresponding to a first type of signal or a data rate corresponding to a second type of signal.

Communication system 500 can comprise a Home Subscriber Server (HSS) 540, a tElephone NUmber Mapping (ENUM) server 530, and other network elements of an IMS network 550. The IMS network 550 can establish communications between IMS-compliant communication devices (CDs) 501, 502, Public Switched Telephone Network (PSTN) CDs 503, 505, and combinations thereof by way of a Media Gateway Control Function (MGCF) 520 coupled to a PSTN network 560. The MGCF 520 need not be used when a communication session involves IMS CD to IMS CD communications. A communication session involving at least one PSTN CD may utilize the MGCF 520.

IMS CDs 501, 502 can register with the IMS network 550 by contacting a Proxy Call Session Control Function (P-CSCF) which communicates with an interrogating CSCF (I-CSCF), which in turn, communicates with a Serving CSCF (S-CSCF) to register the CDs with the HSS 540. To initiate a communication session between CDs, an originating IMS CD 501 can submit a Session Initiation Protocol (SIP INVITE) message to an originating P-CSCF 504 which communicates with a corresponding originating S-CSCF 506. The originating S-CSCF 506 can submit the SIP INVITE message to one or more application servers (ASs) 517 that can provide a variety of services to IMS subscribers.

For example, the application servers 517 can be used to perform originating call feature treatment functions on the calling party number received by the originating S-CSCF 506 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 506 can submit queries to the ENUM system 530 to translate an E.164 telephone number in the SIP INVITE message to a SIP Uniform Resource Identifier (URI) if the terminating communication device is IMS-compliant. The SIP URI can be used by an Interrogating CSCF (I-CSCF) 507 to submit a query to the HSS 540 to identify a terminating S-CSCF 514 associated with a terminating IMS CD such as reference 502. Once identified, the I-CSCF 507 can submit the SIP INVITE message to the terminating S-CSCF 514. The terminating S-CSCF 514 can then identify a terminating P-CSCF 516 associated with the terminating CD 502. The P-CSCF 516 may then signal the CD 502 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 5 may be interchangeable. It is further noted that communication system 500 can be adapted to support video conferencing. In addition, communication system 500 can be adapted to provide the IMS CDs 501, 502 with the multimedia and Internet services of communication system 400 of FIG. 4.

If the terminating communication device is instead a PSTN CD such as CD 503 or CD 505 (in instances where the cellular phone only supports circuit-switched voice communications), the ENUM system 530 can respond with an unsuccessful address resolution which can cause the originating S-CSCF 506 to forward the call to the MGCF 520 via a Breakout Gateway Control Function (BGCF) 519. The MGCF 520 can then initiate the call to the terminating PSTN CD over the PSTN network 560 to enable the calling and called parties to engage in voice and/or data communications.

It is further appreciated that the CDs of FIG. 5 can operate as wireline or wireless devices. For example, the CDs of FIG. 5 can be communicatively coupled to a cellular base station 521, a femtocell, a WiFi router, a Digital Enhanced Cordless Telecommunications (DECT) base unit, or another suitable wireless access unit to establish communications with the IMS network 550 of FIG. 5. The cellular access base station 521 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 5.

Cellular phones supporting LTE can support packet-switched voice and packet-switched data communications and thus may operate as IMS-compliant mobile devices. In this embodiment, the cellular base station 521 may communicate directly with the IMS network 550 as shown by the arrow connecting the cellular base station 521 and the P-CSCF 516.

Alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

The processor 430 of FIG. 4 can be operably coupled to communication system 500 for purposes similar to those described above. Processor 430 can provide computing services to the CDs 501, 502, 503 and 505 of FIG. 5. Processor 430 can be an integral part of the application server 517, which can be adapted to the operations of the IMS network 550.

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as 3^{rd} Generation Partnership Project (3GPP). It is further noted that some or all embodiments of the subject disclosure may in whole or in part modify, supplement, or otherwise supersede final or proposed standards published and promulgated by 3GPP.

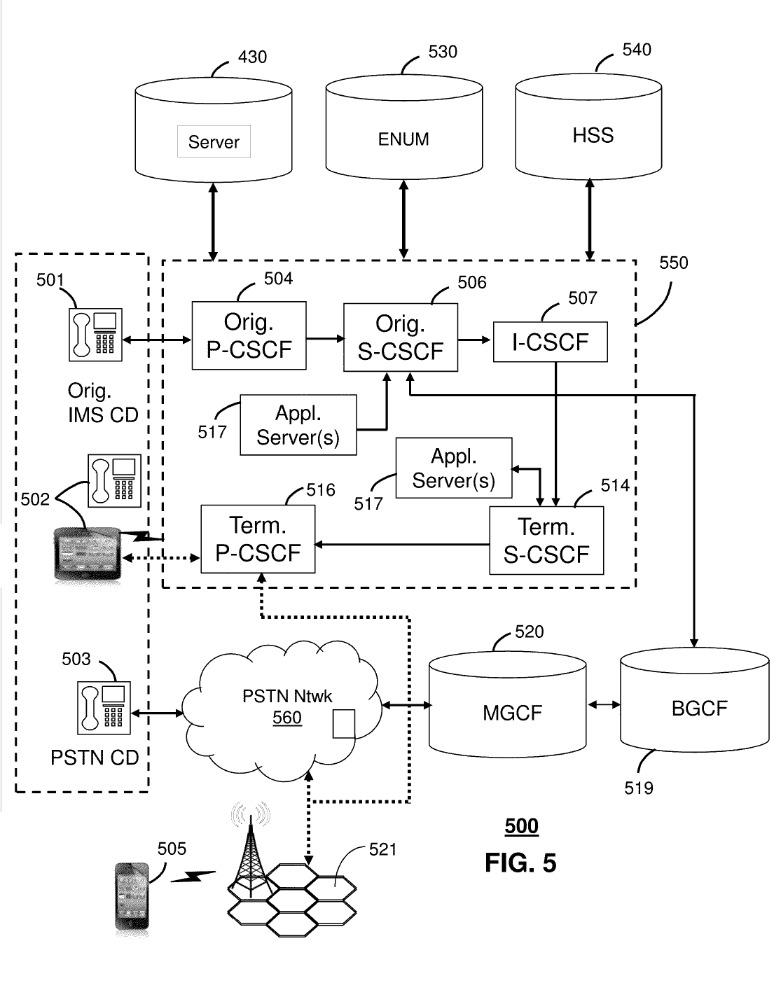

FIG. 6 depicts an illustrative embodiment of a web portal 602 of a communication system 600. Communication system 600 can be overlaid or operably coupled with the system of FIG. 1 and/or FIG. 2, communication system 400, and/or communication system 500 as another representative embodiment of systems 100, 200 of FIG. 1 and/or FIG. 2, communication system 400, and/or communication system 500. The web portal 602 can be used for managing services of systems 110 and/or 200 and communication systems 400-500. A web page of the web portal 602 can be accessed by a Uniform Resource Locator (URL) with an Internet browser using an Internet-capable communication device such as those described in FIGS. 4-5. The web portal 602 can be configured, for example, to access a media processor 406 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 406. The web portal 602 can also be used for provisioning IMS services described earlier, provisioning Internet services, provisioning cellular phone services, and so on.

The web portal 602 can further be utilized to manage and provision software applications to adapt these applications as may be desired by subscribers and/or service providers of systems 100-200 of FIGS. 1 and/or 2, and communication systems 400-500.

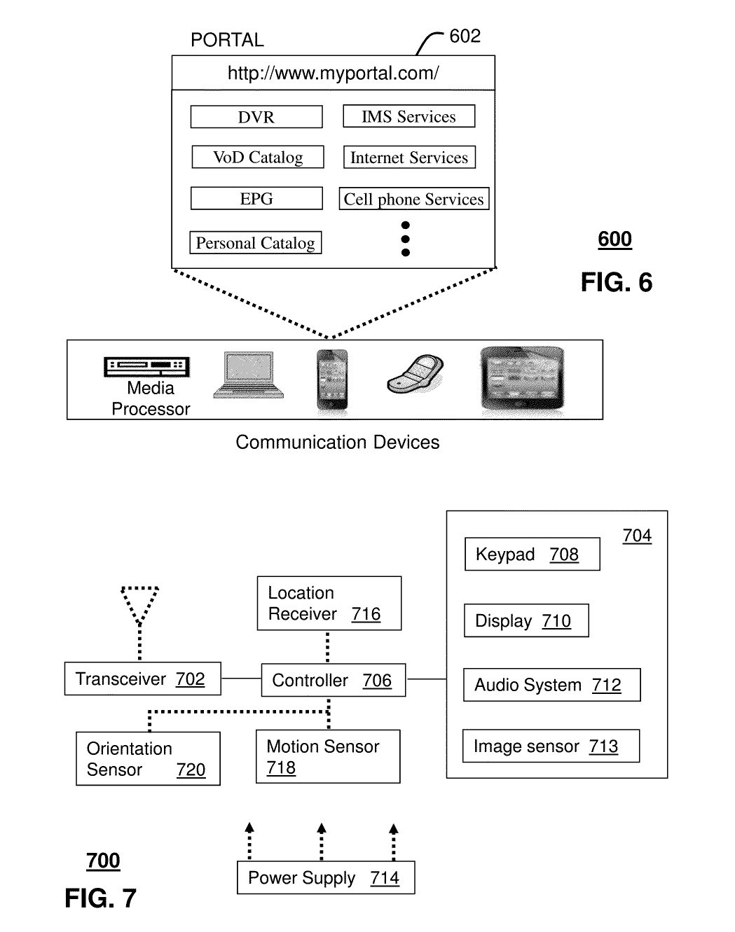

FIG. 7 depicts an illustrative embodiment of a communication device 700. Communication device 700 can serve in whole or in part as an illustrative embodiment of the devices depicted in FIG. 1 and/or FIG. 2, and FIGS. 4-5. Communication device 700 in whole or in part can be configured to perform portions of procedure 300.

Communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth®. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface with graphical user interface (GUI) elements that can be selected by a user with a touch of a finger. The touch screen display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable applications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 700.

Other components not shown in FIG. 7 can be used in one or more embodiments of the subject disclosure. For instance, the communication device 700 can include a reset button (not shown). The reset button can be used to reset the controller 706 of the communication device 700. In yet another embodiment, the communication device 700 can also include a factory default setting button positioned, for example, below a small hole in a housing assembly of the communication device 700 to force the communication device 700 to re-establish factory settings. In this embodiment, a user can use a protruding object such as a pen or paper clip tip to reach into the hole and depress the default setting button. The communication device 700 can also include a slot for adding or removing an identity module such as a Subscriber Identity Module (SIM) card. SIM cards can be used for identifying subscriber services, executing programs, storing subscriber data, and so forth.

The communication device 700 as described herein can operate with more or less of the circuit components shown in FIG. 7. These variant embodiments can be used in one or more embodiments of the subject disclosure.

The communication device 700 can be adapted to perform the functions of processor 221, the media processor 406, the media devices 408, or the portable communication devices 416 of FIG. 4, as well as the IMS CDs 501-502 and PSTN CDs 503-505 of FIG. 5. It will be appreciated that the communication device 700 can also represent other devices that can operate in communication systems 400-500 of FIGS. 4-5 such as a gaming console and a media player.

The communication device 700 shown in FIG. 7 or portions thereof can serve as a representation of one or more of the devices of system 100 and/or system 200, communication system 400, and communication system 500.

Upon reviewing the aforementioned embodiments, it would be evident to an artisan with ordinary skill in the art that said embodiments can be modified, reduced, or enhanced without departing from the scope of the claims described below. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

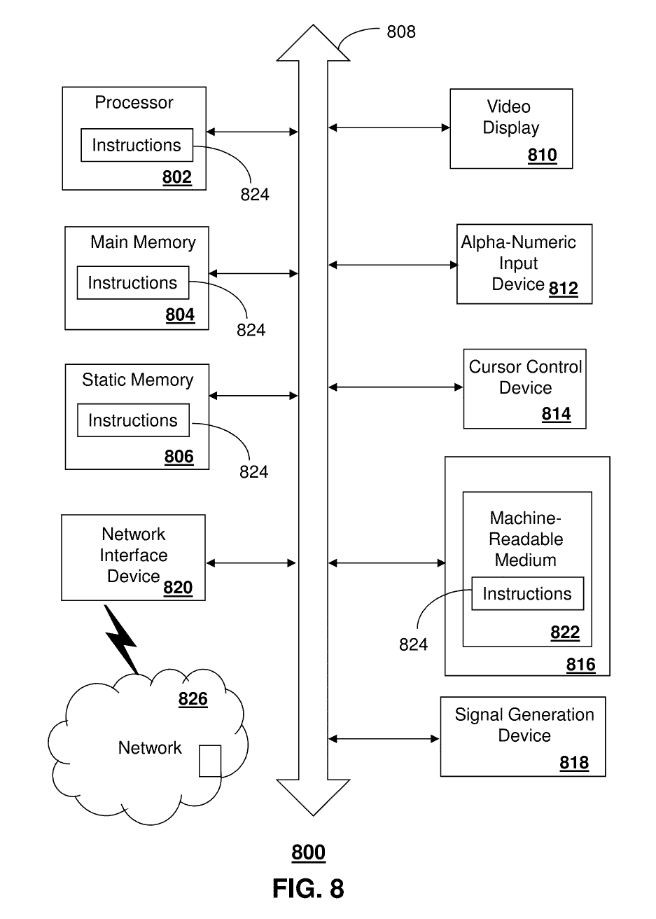

FIG. 8 depicts an exemplary diagrammatic representation of a machine in the form of a computer system 800 within which a set of instructions, when executed, may cause the machine to perform any one or more of the methods described above. One or more instances of the machine can operate, for example, as the processor 430, the media processor 406, or the encoder 101. In particular, one or more instances of the machine may perform some or all of the steps of procedure 300. In some embodiments, the machine may be connected (e.g., using a network 826) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor (or controller) 802 (e.g., a central processing unit (CPU)), a graphics processing unit (GPU, or both), a main memory 804 and a static memory 806, which communicate with each other via a bus 808. The computer system 800 may further include a display unit 810 (e.g., a liquid crystal display (LCD), a flat panel, or a solid state display). The computer system 800 may include an input device 812 (e.g., a keyboard), a cursor control device 814 (e.g., a mouse), a disk drive unit 816, a signal generation device 818 (e.g., a speaker or remote control) and a network interface device 820. In distributed environments, the embodiments described in the subject disclosure can be adapted to utilize multiple display units 810 controlled by two or more computer systems 800. In this configuration, presentations described by the subject disclosure may in part be shown in a first of the display units 810, while the remaining portion is presented in a second of the display units 810.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure. In one or more embodiments, features that are positively recited can also be excluded from the embodiment with or without replacement by another component or step. The steps or functions described with respect to the exemplary processes or methods can be performed in any order. The steps or functions described with respect to the exemplary processes or methods can be performed alone or in combination with other steps or functions (from other embodiments or from other steps that have not been described).

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
an input portion for connecting to a cable delivering a signal, the signal comprising a transport signal with embedded content;
a sensor coupled to the input portion for sensing a time base of the signal, the sensor comprising a phase lock loop;
a switch for routing the signal;
a memory to store executable instructions; and
a processor coupled to the memory, wherein responsive to executing the instructions, the processor performs operations comprising
determining, in accordance with the sensed time base of the signal, whether the signal is of a first type or a second type, and
automatically directing the switch to route the signal to a first input decoder or a second input decoder in accordance with the determining,
wherein the first type of signal is an asynchronous serial interface signal and the second type of signal is a high-definition serial digital interface signal.

2. The apparatus of claim 1, wherein the determining further comprises determining whether the sensed time base of the signal corresponds to a clock rate associated with the first type of signal.

3. The apparatus of claim 1, wherein the embedded content further comprises video content and audio content.

4. The apparatus of claim 1, wherein the input portion further comprises a single connector for connecting to a coaxial cable for inputting signals of both the first type and the second type.

5. The apparatus of claim 2, wherein the apparatus inputs the signal to an internet protocol encoder, and wherein the internet protocol encoder comprises the first input decoder and the second input decoder.

6. The apparatus of claim 2, wherein the clock rate is 270 MHz.

7. The apparatus of claim 2 wherein, in accordance with the sensor failing to sense the time base corresponding to the clock rate associated with the first type of signal, the processor directs the switch to change from a first state to a second state, wherein the switch in the first state routes the signal to the first input decoder and in the second state routes the signal to the second input decoder.

8. An apparatus comprising:
an input portion for connecting to a cable delivering a signal having embedded video content;
a sensor, coupled to the input portion, for sensing a data rate of the signal;
a switch for routing the signal;
a memory to store executable instructions; and
a processor coupled to the memory, wherein responsive to executing the instructions, the processor performs operations comprising:
determining, in accordance with the sensed data rate of the signal, whether the signal is of a first type or a second type, and
automatically directing the switch to route the signal to one of a plurality of input decoders in accordance with the determining,
wherein the first type of signal is an asynchronous serial interface signal and the second type of signal is a high-definition serial digital interface signal.

9. The apparatus of claim 8, wherein the determining further comprises determining whether the sensed data rate of the signal is associated with the second type of signal.

10. The apparatus of claim 8, wherein the signal further comprises a transport signal having embedded video content and audio content.

11. The apparatus of claim 8, wherein the input portion further comprises a single connector for connecting to a coaxial cable for inputting signals of both the first type and the second type.

12. The apparatus of claim 9, wherein the apparatus inputs the signal to an internet protocol encoder, and wherein the internet protocol encoder comprises a first input decoder and a second input decoder.

13. The apparatus of claim 9, wherein the data rate is 1.48 Gbit/sec.

14. The apparatus of claim 9, wherein, in accordance with the sensor failing to sense the data rate associated with the second type of signal, the processor directs the switch to change from a first state to a second state, and wherein the switch in the first state routes the signal to the first input decoder and in the second state routes the signal to the second input decoder.

15. A method comprising:
receiving a signal at an input portion of an internet protocol encoder;
sensing a characteristic of the signal; and
automatically routing the signal to a first decoder portion or a second decoder portion of the internet protocol encoder in accordance with the sensed characteristic,
wherein the characteristic of the signal is a clock rate corresponding to a first type of signal or a data rate corresponding to a second type of signal.

16. The method of claim 15, wherein the signal further comprises a transport signal having embedded video content and audio content.

17. The method of claim 15, wherein the sensed characteristic is a clock rate of 270 MHz corresponding to an asynchronous serial interface signal.

18. The method of claim 15, wherein the sensed characteristic is a data rate of 1.48 Gbit/sec corresponding to a high-definition serial digital interface signal.

19. The method of claim 15, wherein the input portion comprises a single connector for connecting to a coaxial cable for inputting signals of both the first type and the second type.

20. The method of claim 15, wherein the routing is performed by a switch that changes from a first state for routing the signal to the first decoder portion to a second state for routing the signal to the second decoder portion in accordance with a failure to sense the characteristic.
